(19) United States
(12) Patent Application Publication
(10) Pub. No.: US 2018/0087473 A1
(43) Pub. Date: Mar. 29, 2018

(54) DOUBLE-ACTING FREE-PISTON-STIRLING CYCLE MACHINE WITH LINEAR GENERATOR

(71) Applicants: Daniel Bertschi, Gelfingen (CH); Jörg Mafli, Dürrenäsch (CH)

(72) Inventors: Daniel Bertschi, Gelfingen (CH); Jörg Mafli, Dürrenäsch (CH)

(21) Appl. No.: 15/715,352

(22) Filed: Sep. 26, 2017

(30) Foreign Application Priority Data
Sep. 27, 2016 (CH) CH-01262/16

(51) Int. Cl. F02G 1/043

(52) U.S. Cl. CPC F02G 1/0435; F02G 1/05

(57) ABSTRACT

A free-piston Stirling cycle engine includes a hermetically sealed pressure housing with a working section and at least one displacement section adjacent to the working section. At least one working piston, which forms part of a linear generator, is movably arranged in the interior of the working section and a regenerator is arranged in the at least one displacement section such that mechanical work can be performed by the working piston when the pressure housing is filled with a working gas and under the influence of a temperature difference between the displacement section with an elevated temperature and the remainder of the pressure housing with a lower temperature and the mechanical work can be converted into electrical energy by the linear generator.

### TECHNICAL FIELD

The invention pertains to a Stirling engine according to the preamble of claim 1.

The Stirling engine or free-piston Stirling cycle engine comprises a housing with a linear generator that centrally separates the two chambers filled with working gas. The invention converts thermal energy into electrical energy. For reasons of simplicity, the term Stirling engine is used instead of free-piston cycle engine in the following text.

### PRIOR ART

Stirling engines have been used as efficient thermomechanical devices for converting thermal energy into mechanical energy for about 200 years.

Similarly, Stirling refrigeration cycle engines are used for converting mechanical energy into pumping thermal energy from a cooler temperature to a warmer temperature. These refrigeration cycle engines are frequently connected to a linear motor or an AC generator. A Stirling engine can drive a linear AC generator in order to generate electrical energy. Vice versa, a linear AC generator can also drive a Stirling engine for cooling purposes.

According to DE 10 2008 041 076, a hermetically sealed housing is very important for the operation of a Stirling engine. The efficiency factor of the Stirling engine is dependent on the maximum starting pressure of the working gas. The Stirling engine described in the aforementioned publication is considered as the most closely related prior art. Due to the complex internal design of the Stirling engine described in publication DE 10 2008 041 076, the mechanics have to be enclosed in a pressure-tight primary housing. This pressure-tight housing, which was specifically developed for this Stirling engine, represents a high cost factor because it is subjected to a double load by the internal gas pressure and the externally supplied thermal energy of approximately 500° C. It is therefore absolutely imperative to use high-quality materials, which are correspondingly expensive and additionally increase the weight of the Stirling engine. The inventive Stirling engine therefore aims to accommodate the construction in a simple geometric configuration, which withstands the occurring pressures and is available in standard dimensions and shapes.

Like all other known Stirling engines, the Stirling engine described in DE 10 2008 041 076 works against the resistance of a mechanical spring, a diaphragm or the like. This spring has the function of returning the working piston back into the starting position after the expansion of the working gas such that the cycle can begin anew. The efficiency factor is negatively affected because the working piston is drained of energy due to the compression of the spring.

The need for a spring or the like is eliminated in the inventive Stirling engine because compressive forces are alternately generated on both sides of the working piston or linear generator by heating the working gas. The inventive Stirling engine is therefore also referred to as a double action Stirling engine. The double action of the Stirling engine causes a much more harmonic operation because the motion of the working piston from one side to the other side is realized in the same way and no differences in acceleration and deceleration occur. Consequently, a vibratory compensation of the type described in publication DE 10 2008 041 076 is not required.

Another disadvantage of existing Stirling engines is the lack of an efficient power control. A minimal and sluggish power control can be achieved by controlling the supplied heat. The Stirling engine reacts to the changing energy effects with a significant delay. The displacement piston, in particular, significantly affects the speed of the work cycle. In conventional Stirling engines, this displacement piston is mechanically connected to the working piston. This connection is in most cases produced by means of a flywheel.

The connection of the working piston to the displacement piston by means of a flywheel has the disadvantage that the displacement piston is significantly decelerated during the change of direction and then slowly accelerated again. This deceleration reduces the efficiency factor of the Stirling engine. Due to this connection, the displacement piston cannot be used for the power control independently of the working piston.

The connection between the displacement piston and the working piston in the form of a flywheel requires movable mechanical components, e.g. in the form of ball bearings, which are subjected to mechanical and thermal stresses and increase the manufacturing costs. These components also require intensive maintenance and therefore negatively affect the maintenance costs.

The above-described mechanical connections furthermore have the disadvantage that the housing, in which the working gas chamber with the displacement piston is located, has to be penetrated. This penetration cannot be permanently sealed and leads to a reduced efficiency factor.

### DISCLOSURE OF THE INVENTION

The present invention is based on the objective of eliminating the aforementioned disadvantages and developing a Stirling engine, which has an enhanced efficiency and already reaches an increased efficiency factor at smaller temperature differences such that high working gas pressures and working gas temperatures are no longer required.

The inventive Stirling engine does not aim to achieve a very high output power, but rather to utilize small temperature differences below 100° C. In this way, the construction materials used are not subjected to high temperatures such that the manufacturing costs are reduced and the service life is extended.

In the inventive Stirling engine, the displacement piston can be moved independently of the working piston. This motion is realized by means of an electromagnetic field that is generated by a coil outside the housing and inevitably causes the displacement piston to carry out a linear motion in the desired cycle by changing the polarities.

Due to the small temperature difference, it is possible to utilize naturally occurring temperature differences and to convert their heat into electrical energy. The inventive Stirling engine therefore opens up entirely new fields of application and can finally emancipate from fuels such as wood, oil or gas. Existing Stirling engines are currently still heated with conventional fuels in order to achieve the required temperature difference. This deteriorates the carbon footprint and leads to additional particulate pollution due to the combustion.

The inventive Stirling engine is also suitable for using the waste heat of existing machines because part of the waste heat energy can be utilized.

The invention is described below with reference to an exemplary embodiment.

### BRIEF DESCRIPTION OF THE DRAWINGS

In the individual drawings used for elucidating the exemplary embodiment:

FIG. 1a shows a longitudinal section through the inventive Stirling engine in the direction of the axis R with one possible position of the regenerators illustrated in sections II and II′.

FIG. 1b shows a longitudinal section through the inventive Stirling engine in the direction of the axis R with the opposite position of the regenerators referred to FIG. 1a.

FIG. 1c shows an enlarged longitudinal section in the region of the linear generator of the inventive Stirling engine in the direction of the axis R.

FIG. 2 shows a cross section at the height of the regenerator of the inventive Stirling engine transverse to the axis R whereas

FIG. 3 shows a cross section at the height of the linear generator of the inventive Stirling engine transverse to the axis R.

FIG. 4 shows a longitudinal section through a modified Stirling engine in the direction of the axis R, wherein the pressure housing has a constant cross section.

FIG. 5 shows a longitudinal section through two series-connected Stirling engines with only one pressure housing.

### DESCRIPTION

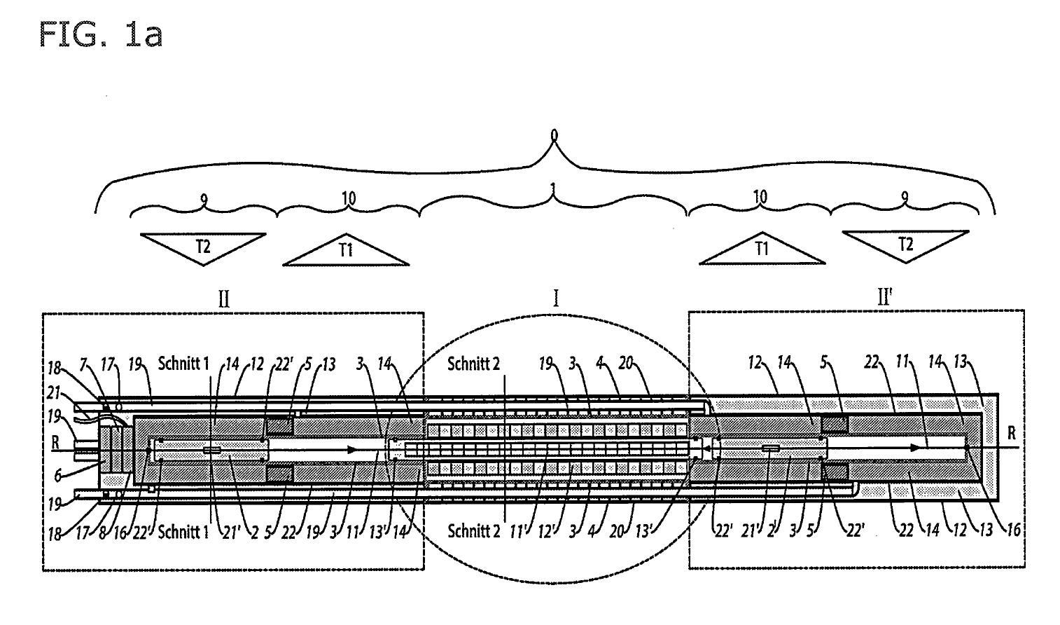

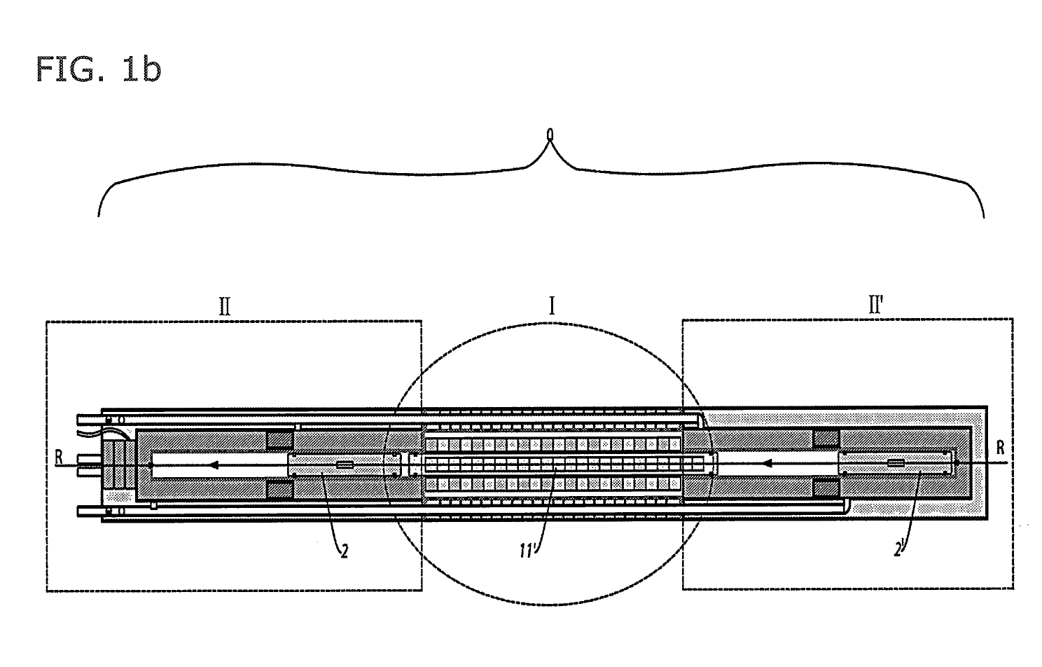

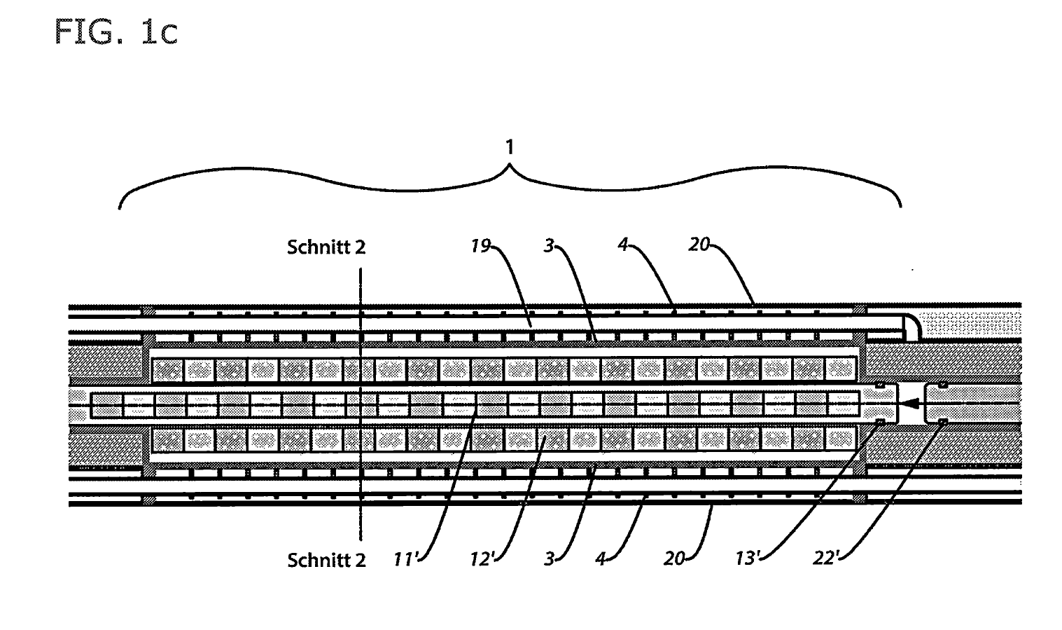

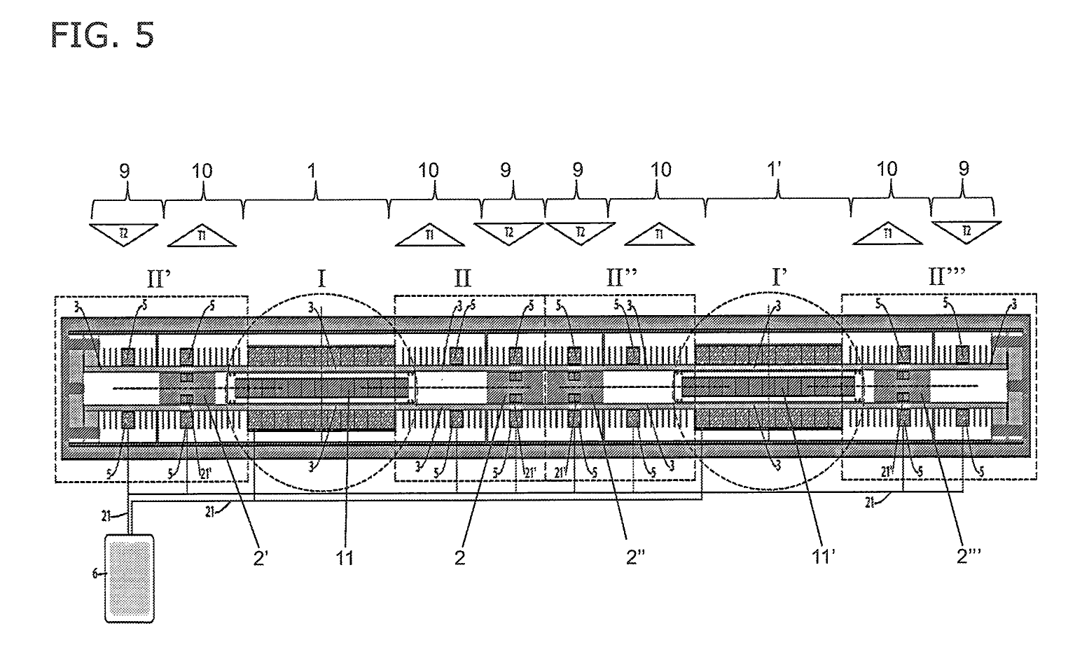

An embodiment of a free-piston Stirling cycle engine 0 or a Stirling engine 0 is illustrated in FIGS. 1-5.

According to FIG. 1a, the Stirling engine 0 comprises three sections that are divided into a section I, a section II and a section II′, wherein a hollow-cylindrical pressure housing 3, which is hermetically sealed and has closed end faces, penetrates all three sections. In the interior of the section I, the pressure housing 3 contains a linear generator 1, which consists of a working piston 11′ with multiple integrated permanent magnets and is sealed with piston rings 13′, as well as a stator with windings 12′. The working piston 11′ forms the armature of the linear generator 1. The stator and the windings 12′ surround the working piston 11′ and are spaced apart therefrom in the section I of the linear generator 1.

Regenerators 2 or displacement pistons 2 are arranged in the sections II and II′, which are located to the left and to the right of the section I within the pressure housing 3, and the interior of the pressure housing 3 is filled with a working gas 11. The regenerators 2 furthermore consist of a permanent magnet 21′ and sliding rings 22′ of abrasion-resistant plastic. The pressure housing 3 respectively features a filler opening 16 for the working gas 11 on both end faces. The working gas 11 is distributed in the interior of the sections II, II′ of the pressure housing 3 and filled therein during the manufacture before thermal insulations are arranged on the pressure housing 3. This Stirling engine 0 can be referred to as a gamma type because the working piston 11′ and both regenerators 2 are accommodated in the same cylindrical interior of the pressure housing 3. The working piston 11′ and the regenerators 2 are arranged in the interior of the pressure housing such that they can be linearly moved in the direction of the axis R, wherein no mechanical connection exists between the working piston 11′ and the regenerators 2. In the position according to FIG. 1a, both regenerators 2 and the working piston 11′ are deflected toward the left side as far as possible.

According to FIG. 1a, at least one induction coil 5 is respectively located in the center of the sections II and II′ outside the pressure housing 3, wherein said induction coil is respectively wound around the pressure housing 3. The induction coil 5 is operated as an electromagnet, to which a current is applied in order to generate a magnetic field that is used for moving the regenerators 2. A heat transfer means 14, which is realized in the form of a foamed metal 14 in this case, is divided into two parts by the induction coil 5. The heat transfer means 14 are important because thermal energy should be transferred to the working gas 11 in the pressure housing 3 as efficiently as possible in the two sections II, II′.

A casing 22 surrounds the foamed metal 14 and the induction coils 5 along the second sections II and II′. In the second sections II, II′, the casing 22 is enclosed by a surrounding thermal insulation 13 with heat supply regions 9 and heat dissipation regions 10. A control module 6 with integrated interfaces such as WLAN and Bluetooth, a rechargeable battery 7 and a frequency converter 8 is positioned within this thermal insulation 13, preferably in the front edge region. An electric line 21 conducts the current of the frequency converter 8 outward. Lines 19 for a heat transfer fluid, preferably water, are arranged in the thermal insulation 13. These lines 19 comprise solenoid valves 18 and sensors 17, wherein the lines 19 essentially extend parallel to the axis R.

A closed cover 12 surrounding the thermal insulation 13 encases the Stirling engine 0 in the second sections II and II′. The lines 19 for the fluid extending in the second sections II, II′ are arranged within the cover 12.

The first section I, in which the linear generator 1 is arranged, is enclosed by a perforated cover 20 that makes it possible to cool the first section I. Cooling fins 4 are arranged between the perforated cover 20 and the pressure housing 3 perpendicular to the axis R and improve the heat dissipation of the linear generator 1 to the ambient air.

According to FIG. 1a, heat is supplied T2 to both outer sides of the Stirling engine 0 in the sections II and II′, namely in the heat supply regions 9. Heat is dissipated T1 in the heat dissipation regions 10 to the left and to the right of the first section I and of the linear generator 1 with the working piston 11′. This is achieved by means of the lines 19, through which warm and cold water is respectively supplied to and discharged from the heat supply regions 9 and the heat dissipation regions 10.

FIG. 1b shows the Stirling engine 0 with different positions of the regenerators 2 and the working piston 11′ referred to FIG. 1a. The regenerator 2 of the second section II is deflected as far as possible in the direction of the working piston 11′ whereas the regenerator 2 of the second section II′ is deflected as far as possible away from the working piston 11′ in the direction of the outer edge of the pressure housing 3.

FIG. 1c shows the section I with the linear generator 1 in the form of an enlarged representation referred to FIG. 1a, wherein said linear generator comprises a working piston 11′ consisting of permanent magnets, which can be moved together with the working piston 11′. Piston rings 13′ arranged on the left and the right outer end of the working piston 11′ such that the linear motion of the working piston 11′ is simplified.

The linear generator 1 also comprises a stator with multiple windings 12′. The linear generator 1 is completely enclosed in the pressure housing 3. The outer wall of the pressure housing 3 features cooling fins 4 in the region of the linear generator 1. The lines 19 are arranged such that they extend through the region of the cooling fins 4.

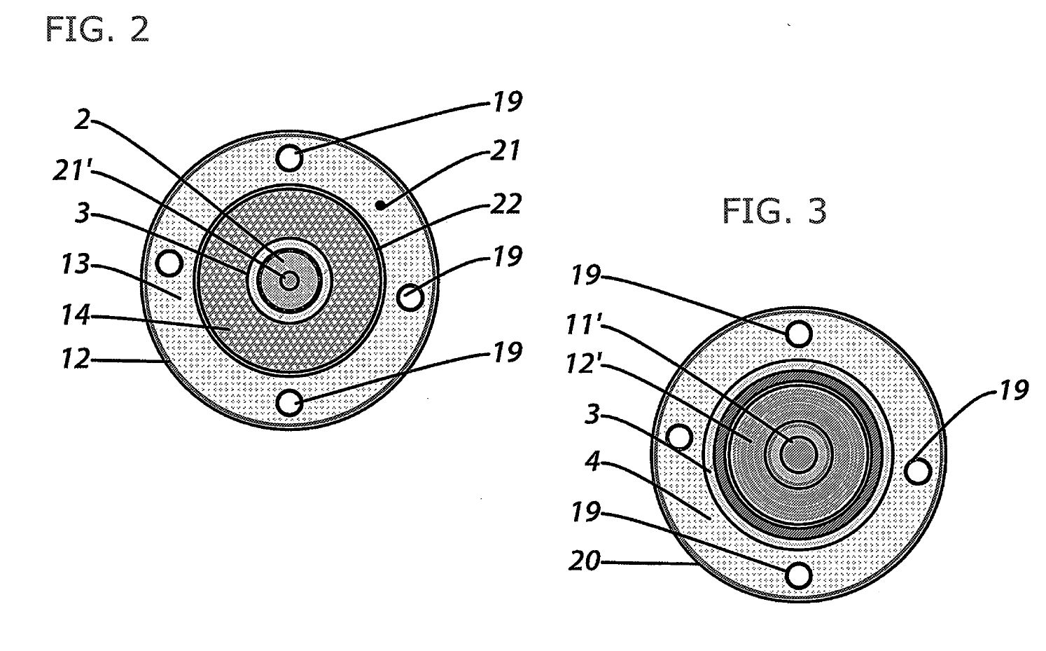

FIG. 2 shows a cross section extending at 90° to the axis R of the Stirling engine 0 illustrated in FIG. 1a, namely in the section II with the permanent magnet 21′ and at the height of a regenerator 2 in the heat supply region 9. The regenerator 2 is located within the pressure housing 3, which is in turn surrounded by the heat transfer means 14 in the form of the foamed metal 14. The casing 22 seals the foamed metal 14 relative to the thermal insulation 13. The lines 19 and the electric line 21 are routed within the thermal insulation 13. All components are enclosed within the cover 12. The lines 19 and the electric lines 21 are embedded in the thermal insulation 13 and only come in contact with ambient air, but not with the heat transfer fluid that flows through the lines 19 and is admitted into the heat transfer means 14 through the casing 22.

FIG. 3 shows the section 2 transverse to the linear generator 1 in the section I. The working piston 11′ comprising permanent magnets is illustrated in the center of FIG. 3, wherein said working piston is surrounded by the stator with the windings 12′ and spaced apart therefrom by a gap. The pressure housing 3 is in turn surrounded by the cooling fins 4. The lines 19 for the heat transfer fluid are routed through the cooling fins 4. All described components are enclosed in the perforated cover 20.

### Ways for Implementing the Invention

The proposed Stirling engine 0 illustrated in the figures converts thermal energy into electrical energy. A heat source, which supplies thermal energy in the form of an elevated temperature T2 to the heat supply regions 9 within the sections II and II′, is required for the operation of the Stirling engine 0. In the embodiment shown, a heat transfer fluid in the form of a warm liquid, e.g. water, is supplied through the lines 19. The flow rate is measured by means of sensors 17. This data is transmitted to the control module 6, which can control the flow rate by means of solenoid valves 18. The supplied heat reaches the region of the heat transfer means 14 in the form of the metal foams 14 through the lines 19 and the metal foams 14 transfer the thermal energy from the heat transfer fluid to the working gas 11 via the pressure housing 3. Normal fins of metal may also be used as heat transfer means 14 as an alternative to the metal foams 14.

The pressure housing 3 is usually produced in three individual parts that are subsequently connected to one another. This ensures that the linear generator 1 can be respectively installed and exchanged.

Helium is advantageously used as working gas 11. Thermal energy is dissipated via the lines 19 in the dissipation region 10 with a lower temperature T1. A temperature difference is now generated between the heat dissipation regions 10 with a lower temperature T1 and the heat supply regions 9 with an elevated temperature T2 outside and inside the pressure housing 3.

According to FIG. 1a, the regenerator 2 in the section II displaces the working gas 11 from the heat supply regions 9 with an elevated temperature T2 into the heat dissipating region 10 with a lower temperature T1. In this heat dissipation region 10, the working gas once again transfers thermal energy to the metal foam 14 via the pressure housing 3. The thermal energy is transferred because the heat transfer fluid, e.g. water, flows through the metal foam 14. The working gas 11 therefore cools down and the internal pressure on the side of the section II of the linear generator 1 drops. The opposite simultaneously takes place on the other side of the linear generator 1 in the section II′. The regenerator 2 displaces the working gas 11 from the cold region 10 of the pressure housing 3 with the temperature T1 to the warm region 9 with the temperature T2. In the positions of the regenerators illustrated in FIG. 1a, a pressure drop takes place in the section II because heat is dissipated and a pressure increase takes place in the section II′ because heat is supplied. This pressure difference inevitably causes a displacement of the working piston 11′ along the axis R in the direction of the section II.

After this work cycle, the regenerators 2 are respectively moved to the opposite side within the sections II and II′ along the axis R as illustrated in FIG. 1b by reversing the polarity of the magnetic field of the induction coil 5. Due to this motion, the working gas 11 is displaced into the region 9 with the elevated temperature T2 as illustrated in the section II in FIG. 1b. It is therefore heated and presses the working piston 11′ in the direction of the section II′ along the axis R while the regenerator 2 in the section II′ is located in the region 9 with the elevated temperature T2 and the working gas 11 is displaced into the region 10 with the lower temperature T1. The pressure of the working gas in the section II′ therefore drops and the resistance to a displacement of the working piston 11′ into this section is reduced.

The regenerators 2 are short-term heat accumulators and are supplied with thermal energy by the working gas 11 on one side in order to once again transfer the thermal energy to the working gas 11 on the opposite side. The regenerators 2 advantageously consist of a material with high thermal capacity. Since the regenerators 2 slightly delay this heat flow, a higher temperature gradient is generated between the working gas volumes 11 to the left and to the right of the regenerators 2. The working gas 11 therefore expands and acts upon the end face of the working piston 11′ of the linear generator 1 along the axis R. The piston ring 13′ prevents the working gas 11 from being admitted into the linear generator 1. A pressure difference of the working gas 11 is now generated between the hollow spaces of the pressure housing 3 separated by the linear generator 1. The resulting forces acting upon the working piston 11′ set this working piston in motion parallel to the axis R. The working piston 11′ provided with permanent magnets induces an electric voltage with its magnetic field by means of the stator with its windings 12′. This voltage is fed to the frequency converter 8 via the electric lines 21, wherein this frequency converter increases the frequency to the customary 50 Hz such that the generated current can be supplied to an external consumer.

The double action of the Stirling engine 0 is achieved in that the working gas 11 can alternately act upon the working piston 11′ on both sides of the linear generator 1 by simultaneously subjecting the working gas to different temperatures on both sides of the linear generator 1 in the above-described fashion such that the pressure increases on one side and simultaneously drops on the opposite side.

The induction coil 5 generates a directional magnetic field for moving the regenerators 2, wherein the induction coil consists of a copper wire winding and is supplied with power by the control module 6. The induction coils 5 therefore form an electromagnet, by means of which the regenerators 2 can be positioned in a controlled fashion. The regenerators 2 therefore have to be permanently magnetic or be provided with a permanent magnet 21′ as shown. Sliding rings 22′ of metal or plastic are used in order to keep the frictional resistance to a minimum and to prevent wear of the regenerator.

Additional energy is required for starting the Stirling engine 0. This additional energy is supplied by the rechargeable battery 7. The rechargeable battery 7 is charged with internally generated electrical energy during the operation of the Stirling engine 0 in order to once again provide the required starting energy for moving the regenerators 2 by means of the induction coil 5 after a standstill.

The control module 6 monitors the heat flow, which is externally supplied into the Stirling engine through the line 19 for the fluid, by means of the sensors 17. The control module 6 consists of a processor for processing the incoming data such as temperature, flow rate, voltage and amperage. Based on this data, the control module 6 controls the work cycle of the regenerators 2 by means of the induction coil 5. The control module 6 also controls the flow rate of the fluid with the aid of the solenoid valves 18. In a first embodiment, the control module 6 provides an interface that may be selectively realized in the form of a Bluetooth, WLAN or USB interface. This interface serves for controlling, monitoring and adjusting the Stirling engine 0 by the user.

The Stirling engine 0 is in the section I closed with a perforated cover 20 around the linear generator 1 in order to ensure that the waste heat of the linear generator 1 can be dissipated into the ambient air by means of the cooling fins 4 and through the perforated cover 20.

In this embodiment, a double action of the Stirling engine 0 is achieved in that the two displacement sections II, II′ are adjacently arranged to both sides of the working section I, wherein the pressure housing 3 encloses an interior, in which the working gas 11, the working piston 11′ and both regenerators 2 are arranged in a linearly movable fashion. The regenerators 2 move to both sides of the working section I and therefore to both sides of the linear generator 1. In order to achieve a high efficiency factor, the working gas 11 in the sections II and II′ should not balance out via the working section I. The piston rings 13′ and the sliding rings 22′ prevent the working gas 11 from exiting the sections II and II′ and being admitted into the section I. At these locations, the pressure housing 3 encloses the linear generator 1 in order to contain the working gas 11 flowing past the piston ring 13′ and the sliding rings 22′ in the closed system. When the Stirling engine 0 or the working piston 11′ and the regenerators 2 is/are at a standstill, the working gas 11 once again balances out within the entire pressure housing 3. In practical applications, it is also admitted into the section I because pressures of approximately 200 bar are generated. If the working gas 11 would be able to balance out between the displacement sections II and II′ without any resistance, no pressure difference could be generated between the sections I, II, II′ and the working piston 11′ would not be driven.

In this embodiment, two sections II, II′ are laterally arranged on the working section I in order to eliminate the need for a return spring, by means of which the working piston is once again returned into the starting position in conventional Stirling engines. The disadvantage of a return spring can be seen in that it consumes kinetic energy and that the working piston has to pressed against the spring. In this embodiment, overpressure and underpressure is alternately generated to both sides of the linear generator 1 such that the working piston 11 can be moved between its deflecting positions with less resistance.

In a slightly modified variation, the Stirling engine 0 may be designed in such a way that the linear generator 1 has the axis R and the pressure housing 3 is angled relative to the axis R by an angle greater than 0° in the region of the two regenerators 2. Accordingly, the displacement sections II, II′ are then arranged angular to the first section I, preferably by an angle relative to the axis R that forms a zero line. In an angular configuration, it would be preferred to choose an angle of 90° such that the Stirling engine 0 has a U-shape.

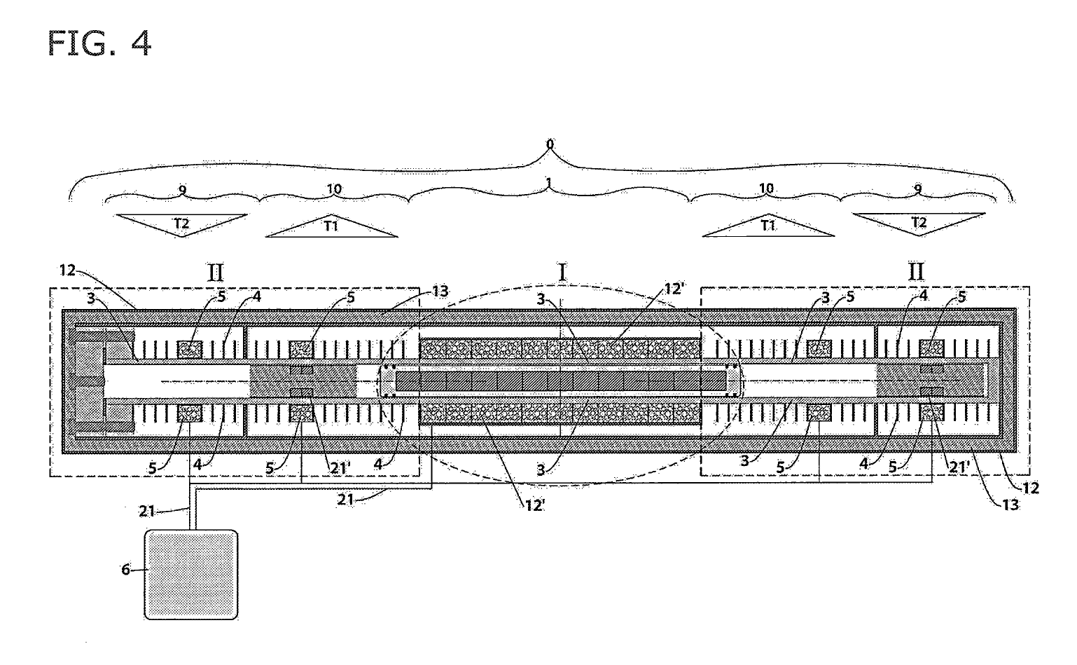

Tests have shown that it is respectively possible and advantageous to arrange the stator with its windings 12′ outside the pressure housing 3 contrary to the version illustrated in FIGS. 1a and 1b. In this embodiment, the stator 12′ is arranged outside a tubular pressure housing 3 with constant cross section. In this case, the windings of the stator 12′ are wound such that they enclose the pressure housing 3. This can be gathered from FIG. 4. In a modified variation, the control module 6 and various electric lines 21 are arranged outside the Stirling engine 0, wherein the electric lines 21 extend as far as the induction coils 5 on the pressure housing 3. This figure does not show the rechargeable battery 7 and the frequency converter 8, which are arranged outside the Stirling engine 0, particularly outside the cover 12. In this embodiment, a plurality of cooling fins 4 are provided on the pressure housing 3 as heat transfer means 14 instead of the foamed metal.

In a preferred embodiment of the Stirling engine 0′, in which vibrations are largely prevented, a series connection of at least two Stirling engines 0 is produced. Both Stirling engines 0 are preferably aligned along the axis R and comprise a single closed pressure housing 3. The single pressure housing 3 filled with working gas 11 makes it possible to produce a functional connection of the sections I, I′, II, II′, II″, II′″. All displacement sections II, II′, II″, II′″ with regenerators 2, 2′, 2″, 2′″ and all working sections I, I′ are arranged in the same pressure housing 3 at a distance from one another. In this case, at least two linear generators 1, 1′ are respectively arranged to both sides of two regenerators 2, 2′, 2″, 2′″ in the longitudinal direction R. All regenerators 2, 2′, 2″, 2″, as well as all working pistons 11′, are arranged within the same pressure housing 3 in a movable and functionally connected fashion. In this embodiment, the regenerators 2, 2′, 2″, 2′″ are also permanently magnetic or feature a permanent magnet 21′. Multiple induction coils 5 at least partially surround the displacement sections II, II′, II″, II′″. The induction coils 5 are arranged outside the pressure housing 3, but within the cover 12, as close as possible to the wall of the pressure housing 3.

The forces of the respectively opposite motions of the working pistons 11′ and the displacement pistons nearly cancel out one another and therefore result in a quiet and low-vibration operation of the combined Stirling engine 0′.

The applicant refers to the above-disclosed Stirling engine 0 and a series connection thereof as a delta Stirling engine, wherein both embodiments can be operated without harmful refrigerants, which represents the decisive competitive advantage.

Stirling engines have also been used for generating very low temperatures in cryogenic engineering for quite some time. The above-described delta Stirling engine 0 can be used for all applications, wherein the simple delta design is optimally suited for small structural shapes, which are absolutely imperative in refrigerators and air-conditioning systems. Its unique function is efficient, cost-effective and environmentally compatible. When a conventional refrigerant is used, it is always necessary to reach the condensation pressure by means of a compressor, wherein the condensation pressure is dependent on the refrigerant such that the evaporation can take place at the desired temperature. The described Stirling engines 0 can also be operated with low delta temperatures. The control is merely based on the compression ratio (gas) and the cycle frequency of the regenerator or regenerators.

### LIST OF REFERENCE SYMBOLS

0 Free-piston Stirling cycle engine/Stirling engine
1 Linear generator
11′ Working piston (armature with permanent magnets)
12′ Stator with windings
13′ Piston ring
2 Regenerators (displacement pistons)
21′ Permanent magnet
22′ Sliding ring
3 Pressure housing
4 Cooling fins
5 Induction coil
6 Control module
7 Rechargeable battery
8 Frequency converter
9 Heat supply region/elevated temperature T2
10 Heat dissipation region/lower temperature T1
11 Working gas
12 Cover
13 Thermal insulation
14 Heat transfer means/foamed metal
15 Thermal separation with seal
16 Filler opening for working gas
17 Sensors
18 Solenoid valves
19 Line for fluid
20 Perforated cover
21 Electric line
22 Casing
R Axis
I First section
II, II′ Displacement sections/second sections

1. A Stirling engine comprising a hermetically sealed pressure housing with a working section and at least one displacement section adjacent to the working section, wherein at least one working piston, which forms part of a linear generator, is movably arranged in the interior of the pressure housing in the working section and a regenerator is arranged in the at least one displacement section such that mechanical work can be performed by the working piston when the pressure housing is filled with a working gas and under the influence of a temperature difference between the displacement section with an elevated temperature and the remainder of the pressure housing with a lower temperature and said mechanical work can be converted into electrical energy by the linear generator,
wherein
a second displacement section with a regenerator is arranged in the same pressure housing at a distance from the working section and the first displacement section such that the displacement sections are arranged directly adjacent to both sides of the working section along a longitudinal axis, wherein the two regenerators are permanently magnetic or comprise a permanent magnet and functionally connected to induction coils, which surround each displacement section, in such a way that the position of the regenerators can be varied by adjusting the current flowing through the induction coils.

2. The Stirling engine according to claim 1, wherein piston rings are arranged on the working piston and sliding rings are arranged on the regenerators in order to impede the exchange of a working gas between the first section and the displacement sections within the pressure housing.

3. The Stirling engine according to claim 1, wherein a stator of the linear generator with windings is completely arranged in the pressure housing and the working piston forms the armature of the linear generator.

4. The Stirling engine according to claim 1, wherein a stator of the linear generator with windings is arranged outside the pressure housing such that it surrounds the pressure housing, and wherein the working piston forms the armature of the linear generator.

5. The Stirling engine according to claim 1, wherein the Stirling engine features a control module, which collects and processes data such as the temperature and the flow rate of a heat transfer fluid from sensors, wherein the flow rate can be controlled by solenoid valves.

6. The Stirling engine according to claim 5, wherein the control module can control the motion cycle of the regenerators by reversing the polarity of the induction coils and thereby directly influence the cycle of the working piston, which defines the induced amount of electrical energy obtained.

7. The Stirling engine according to claim 1, wherein a rechargeable battery provides the required starting energy for starting the Stirling engine by moving the regenerators with the aid of the induction coil, wherein the rechargeable battery can be recharged during the operation with converted energy of the linear generator.

8. The Stirling engine according to claim 1, wherein the regenerators are provided with integrated dry-running sliding rings, particularly of abrasion-resistant plastics, and therefore operate without requiring maintenance.

9. The Stirling engine according to claim 1, wherein the displacement sections are outside the pressure housing enclosed by a heat transfer means that is permeable to a heat transfer fluid.

10. The Stirling engine according to claim 9, wherein the heat transfer means is realized in the form of a foamed metal, the porosity of which allows the heat transfer fluid to flow through.

11. The Stirling engine according to claim 4, wherein the control module features a wireless interface such as WLAN or Bluetooth and can be monitored and controlled by an external PC, a tablet or a smartphone.

12. The Stirling engine according to claim 1, wherein a frequency converter converts the current induced by the linear generator to an alternating voltage frequency of 50 Hz such that the electrical energy can either be fed directly into the power grid or to a consumer.

13. The Stirling engine according to claim 1, wherein each displacement section features a heat supply region on its side facing away from the working section and a heat dissipation region on its side facing the working section, wherein a heat transfer fluid can be respectively supplied to and discharged from said regions by lines.

14. The Stirling engine according to claim 1, wherein a series connection of at least two linear generators with regenerators, which respectively surround the linear generators on both sides in the longitudinal direction of the linear generators, is produced, and wherein all regenerators and all working pistons are arranged within the same pressure housing in a movable and functionally connected fashion.
